(19) United States
(12) Patent Application Publication
(10) Pub. No.: US 2026/0330148 A1
(43) Pub. Date: Oct. 22, 2026

(54) SYSTEM, DEVICE, AND METHOD FOR ASSISTIVE COMMUNICATION

(71) Applicant: Centre for Perceptual and Interactive Intelligence (CPII) Limited, Pak Shek Kok (CN)

(72) Inventor: Yuen Yan Chan, Pak Shek Kok (CN)

(21) Appl. No.: 19/185,444

(22) Filed: Apr. 22, 2025

(51) Int. Cl. G06F 40/40

(52) U.S. Cl. CPC G06F 40/40

(57) ABSTRACT

System, device, and method for assistive communication. The system may include a message generator. The message generator may be configured to: receive one or more communication tokens for constructing a message for communication, retrieve information for constructing the message based at least in part on the one or more communication tokens, generate an input for a natural language processing model based at least in part on the retrieved information and the one or more communication tokens, and obtain an output based at least in part on applying the input to the natural language processing model. The output may include one or more messages constructed based at least in part on the input. The message generator may be configured to output the one or more messages.

### TECHNICAL FIELD

The invention relates to system, device, and method for assistive communication such as augmentative and alternative communication (AAC).

### BACKGROUND

Individuals with complex communication needs (CCN), such as those suffering from autism spectrum disorder (ASD), cerebral palsy, stroke, speech and/or motor impairments, etc., may struggle to communicate or otherwise express themselves effectively.

Assistive communication technologies, such as AAC technologies, can be used to address or at least ameliorate the communication issues encountered by the individuals with CCN.

Existing assistive communication technologies range from low-tech solutions such as non-electronic tools (e.g., picture boards) to high-tech solutions such as speech-generating devices. These existing systems may lack the necessary flexibility and adaptability to facilitate natural and/or context-aware communication, e.g., in dynamic communication environments.

### SUMMARY

In a first aspect, there is provided a system for assistive communication. The system comprises a message generator, which comprises at least one memory and at least one processor operably connected with the at least one memory. The message generator is configured to: receive one or more communication tokens for constructing a message for communication; retrieve information for constructing the message based at least in part on the one or more communication tokens; generate an input for a natural language processing model based at least in part on the retrieved information and the one or more communication tokens; obtain an output based at least in part on applying the input to the natural language processing model, the output comprises one or more messages constructed based at least in part on the input; and output the one or more messages.

In one embodiment of the first aspect, the one or more communication tokens are each associated with an augmentative and alternative communication (AAC) vocabulary. For example, each communication token may be one of: a digital text-based token, a digital symbol-based token, a digital audio token, etc.

In one embodiment of the first aspect, each of the one or more communication tokens is associated with a language unit corresponding to a word or a phrase.

In one embodiment of the first aspect, the information comprises one or more of: contextual information associated with the one or more communication tokens, communication history of a user, or interaction history of the user.

In one embodiment of the first aspect, the message generator is configured to retrieve the information from a data source, and the data source comprises one or more of: a structured database, an unstructured data repository, a domain-specific knowledge base, or a user history database.

In one embodiment of the first aspect, the natural language processing model comprises a large language model (LLM).

In one embodiment of the first aspect, the one or more messages each comprises a sentence. The sentence may be, e.g., a declarative sentence (statement), an imperative sentence (command), an exclamatory sentence (exclamation), or an interrogative sentence (question).

In one embodiment of the first aspect, the message generator is configured to: in response to the output of the one or more messages, receive a feedback associated with a utility (usefulness) of at least one of the one or more messages; and adapt (e.g., fine-tune) the natural language processing model based at least in part on the feedback.

In one embodiment of the first aspect, the feedback is associated with a selection of one of the one or more messages for communication.

In one embodiment of the first aspect, the output further comprises one or more updated communication tokens, and the message generator is configured to output the one or more updated communication tokens. Each updated communication token may be associated with an AAC vocabulary.

In one embodiment of the first aspect, the message generator is configured to: in response to the output of the one or more updated communication tokens, receive one or more further communication tokens (for constructing a/the message); retrieve further information (for constructing a/the message) based at least in part on the one or more further communication tokens; generate a further input for the natural language processing model based at least in part on the further retrieved information and the one or more further communication tokens; obtain a further output based at least in part on applying the further input to the natural language processing model, the further output comprises one or more further messages constructed based at least in part on the further input; and output the one or more further messages.

In one embodiment of the first aspect, the further information comprises one or more of: contextual information associated with the one or more further communication tokens, communication history of the user, or interaction history of the user. In one embodiment of the first aspect, the one or more further messages each comprises a sentence.

In one embodiment of the first aspect, the message generator is configured to: in response to the output of the one or more further messages, receive a feedback associated with a utility of at least one of the one or more further messages; and adapt (e.g., fine-tune) the natural language processing model based at least in part on the feedback.

In one embodiment of the first aspect, the feedback is associated with a selection of one of the one or more further messages for communication.

In one embodiment of the first aspect, the system further comprises a user interface operably connected with the message generator. The user interface may include at least one input device and at least one output device. The user interface is configured to: present (e.g., visually or verbally) a set of communication tokens which comprises the one or more communication tokens; receive a user input associated with selecting the one or more communication tokens from the set of communication tokens; and output the one or more communication tokens to the message generator for constructing the message for communication.

In one embodiment of the first aspect, the user interface is configured to provide a voice or speech output of one or more messages.

In one embodiment of the first aspect, the user interface is further configured to: present (e.g., visually or verbally) a set of messages which comprises the one or more messages; receive a user input associated with a utility of at least one message of the set of messages; and output a feedback associated with the utility to the message generator.

In one embodiment of the first aspect, the user input comprises a selection of one of the one or more messages for communication, and the user interface is further configured to provide a voice or speech output of the selected message.

In one embodiment of the first aspect, the user interface is further configured to: obtain one or more updated communication tokens; present (e.g., visually or verbally) an updated set of communication tokens which comprises the one or more updated communication tokens; receive a user input associated with selecting one or more communication tokens from the updated set of communication tokens; output the one or more selected communication tokens to the message generator for constructing the message for communication; obtain one or more further messages; present (e.g., visually or verbally) an updated set of messages which comprises the one or more further messages; receive a user input associated with a utility of at least one message of the updated set of messages; and output a feedback associated with the utility to the message generator.

In one embodiment of the first aspect, the user input comprises a selection of one of the one or more further messages for communication, and the user interface is further configured to provide a voice or speech output of the selected message.

In one embodiment of the first aspect, the user interface comprises a multimodal user interface configured to receive user input based at least in part on gaze, speech, bioelectrical (e.g., brain) signals, or any combination thereof.

In one embodiment of the first aspect, the system may be implemented on a single device. In one embodiment of the first aspect, the system may be implemented on multiple devices that are operably (directly or indirectly) connected.

In a second aspect, there is provided a method for assistive communication. The method comprises: receiving one or more communication tokens for constructing a message for communication; retrieving information for constructing the message based at least in part on the one or more communication tokens; generating an input for a natural language processing model based at least in part on the retrieved information and the one or more communication tokens; obtaining an output based at least in part on applying the input to the natural language processing model, the output comprising one or more messages constructed based at least in part on the input; and outputting the one or more messages.

In one embodiment of the second aspect, the one or more communication tokens are each associated with an AAC vocabulary. For example, each communication token may be one of: a digital text-based token, a digital symbol-based token, a digital audio token, etc.

In one embodiment of the second aspect, each of the one or more communication tokens is associated with a language unit corresponding to a word or a phrase.

In one embodiment of the second aspect, the information comprises one or more of: contextual information associated with the one or more communication tokens, communication history of a user, or interaction history of the user.

In one embodiment of the second aspect, the method comprises retrieving the information from a data source, the data source comprises one or more of: a structured database, an unstructured data repository, a domain-specific knowledge base, or a user history database.

In one embodiment of the second aspect, the natural language processing model comprises an LLM.

In one embodiment of the second aspect, the one or more messages each comprises a sentence. The sentence may be, e.g., a declarative sentence (statement), an imperative sentence (command), an exclamatory sentence (exclamation), or an interrogative sentence (question).

In one embodiment of the second aspect, the method comprises: in response to outputting of the one or more messages, receiving a feedback associated with a utility (usefulness) of at least one of the one or more messages; and adapting (e.g., fine-tuning) the natural language processing model based at least in part on the feedback.

In one embodiment of the second aspect, the feedback is associated with a selection of one of the one or more messages for communication.

In one embodiment of the second aspect, the output further comprises one or more updated communication tokens, and the method comprises outputting the one or more updated communication tokens. Each updated communication token may be associated with an AAC vocabulary.

In one embodiment of the second aspect, the method comprises: in response to the output of the one or more updated communication tokens, receiving one or more further communication tokens (for constructing a/the message); retrieving further information (for constructing a/the message) based at least in part on the one or more further communication tokens; generating a further input for the natural language processing model based at least in part on the further retrieved information and the one or more further communication tokens; obtaining a further output based at least in part on applying the further input to the natural language processing model, the further output comprises one or more further messages constructed based at least in part on the further input; and outputting the one or more further messages.

In one embodiment of the second aspect, the further information comprises one or more of: contextual information associated with the one or more further communication tokens, communication history of the user, or interaction history of the user. In one embodiment of the second aspect, the one or more further messages each comprises a sentence.

In one embodiment of the second aspect, the method comprises: in response to outputting the one or more further messages, receiving a feedback associated with a utility of at least one of the one or more further messages; and adapting (e.g., fine-tune) the natural language processing model based at least in part on the feedback.

In one embodiment of the second aspect, the feedback is associated with a selection of one of the one or more further messages for communication.

In one embodiment of the second aspect, the method may be performed by a message generator.

In a third aspect, there is provided a method for assistive communication. The method comprises: presenting (e.g., visually or verbally) a set of communication tokens which comprises one or more communication tokens; receiving a user input associated with selecting the one or more communication tokens from the set of communication tokens; and outputting the one or more communication tokens for constructing a message for communication.

In one embodiment of the third aspect, the method comprises providing a voice or speech output of one or more messages.

In one embodiment of the third aspect, the method comprises: presenting (e.g., visually or verbally) a set of messages which comprises one or more messages; receiving a user input associated with a utility of at least one message of the set of messages; and outputting a feedback associated with the utility.

In one embodiment of the third aspect, the user input comprises a selection of one of the one or more messages for communication, and the method comprises providing a voice or speech output of the selected message.

In one embodiment of the third aspect, the method comprises: obtaining one or more updated communication tokens; presenting (e.g., visually or verbally) an updated set of communication tokens which comprises the one or more updated communication tokens; receiving a user input associated with selecting one or more communication tokens from the updated set of communication tokens; outputting the one or more selected communication tokens for constructing the message for communication; obtaining one or more further messages; presenting (e.g., visually or verbally) an updated set of messages which comprises the one or more further messages; receiving a user input associated with a utility of at least one message of the updated set of messages; and outputting a feedback associated with the utility.

In one embodiment of the third aspect, the user input comprises a selection of one of the one or more further messages for communication, and the method comprises providing a voice or speech output of the selected message.

In one embodiment of the third aspect, the method may be performed by a user interface.

The user interface may comprise a multimodal user interface configured to receive user input based at least in part on gaze, speech, bioelectric (e.g., brain) signals, or any combination thereof.

In a fourth aspect, there is provided a method comprising the method of the second aspect and the method of the third aspect.

In a fifth aspect, there is provided a system comprising means for performing the method second aspect and/or the method of the third aspect.

In a sixth aspect, there is provided an assistive communication device comprising at least one memory, and at least one processor operably connected with the at least one memory. The at least one processor is configured to: output a set of communication tokens; receive a user input associated with selection of one or more communication tokens of the set of communication tokens for constructing a message for communication; obtain, based at least in part on performing retrieval-augmented generation (RAG) using at least the one or more selected communication tokens, an output comprising one or more messages; and output the one or more messages.

In one embodiment of the sixth aspect, the set of communication tokens comprises a plurality of communication tokens each associated with an AAC vocabulary.

In one embodiment of the sixth aspect, the one or more messages each comprises a sentence.

In one embodiment of the sixth aspect, the RAG comprises: retrieving information for constructing the message based at least in part on the one or more selected communication tokens; generating an input for a natural language processing model based at least in part on the retrieved information and the one or more selected communication tokens; and applying the input to the natural language processing model to obtain the output.

In one embodiment of the sixth aspect, the information comprises one or more of: contextual information associated with the one or more selected communication tokens, communication history of a user, or interaction history of the user.

In one embodiment of the sixth aspect, the natural language processing model comprises an LLM.

In one embodiment of the sixth aspect, the at least one processor is configured to: receive a user input comprising a selection of one of the one or more messages for communication, and initiate a voice or speech output of the selected message.

In one embodiment of the sixth aspect, the output further comprises one or more updated communication tokens, and wherein the at least one processor is configured to: update the set of communication tokens based at least in part on the one or more updated communication tokens. Each updated communication token may be associated with an AAC vocabulary.

In one embodiment of the sixth aspect, the at least one processor is configured to: output the updated set of communication tokens; receive a user input associated with a further selection of one or more communication tokens of the updated set of communication tokens; obtain, based at least in part on performing RAG using at least the one or more further selected communication tokens, a further output comprising one or more further messages; and output the one or more further messages.

In one embodiment of the sixth aspect, the RAG comprises: retrieving further information (for constructing a/the) message based at least in part on the one or more further selected communication tokens; generating a further input for the natural language processing model based at least in part on the retrieved further information and the one or more further selected communication tokens; and applying the further input to the natural language processing model to obtain the further output. The further output may further comprise one or more updated communication tokens. The one or more further messages may each comprise a sentence.

In one embodiment of the sixth aspect, the at least one processor is configured to: receive a user input comprising a selection of one of the one or more further messages for communication, and initiate a voice or speech output of the selected message.

In one embodiment of the sixth aspect, the at least one processor is configured to: receive the user input based at least in part on touch, gaze, speech, bioelectric signals, or any combination thereof.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

### BRIEF DESCRIPTION OF THE DRAWINGS

Some embodiments of the invention will now be described, with reference to the accompanying drawings, in which:

FIG. 1 is a schematic diagram of an assistive communication system in one embodiment;

FIG. 2 is a flowchart illustrating a method for assistive communication in one embodiment;

FIG. 3 is a flowchart illustrating a method for assistive communication in one embodiment;

FIG. 4 is a schematic diagram of an assistive communication device in one embodiment;

FIG. 5 is a flowchart illustrating a method for assistive communication in one embodiment;

FIG. 6 is a schematic diagram of a system for assistive communication in one embodiment;

FIG. 7A illustrates a vocabulary selection interface of the system of FIG. 6 in one embodiment;

FIG. 7B is illustrates a sentence construction interface of the system of FIG. 6 in one embodiment;

FIG. 8 is schematic diagram illustrating an example operation of the system of FIG. 6 in one embodiment;

FIG. 9 is a flowchart illustrating an example use case of the system of FIG. 6;

FIG. 10 is a flowchart illustrating an example use case of the system of FIG. 6;

FIG. 11 is a flowchart illustrating an example use case of the system of FIG. 6; and

FIG. 12 is a block diagram of a system for assistive communication in one embodiment.

### DETAILED DESCRIPTION

Embodiments disclosed herein relate to assistive communication technologies.

Existing assistive communication technologies may have various limitations. In one example, some existing assistive communication systems may lack the capability to adapt to different communication contexts (e.g., home, school, workplace, therapy, or other environments), in which a user may encounter varying vocabularies, discourse structures, expectations, etc. In another example, some existing assistive communication systems may be restricted to fixed vocabularies or may require a user to manually select words from a limited set of predefined phrases. This process can be slow and cumbersome, and it may hinder the efficiency and fluidity of communication. In yet another example, some existing assistive communication systems may require a user to provide input physically so thus individuals with motor impairments may struggle to input text or select tokens for interacting with the systems, especially when constructing more complex thoughts or longer sentences. Such physical barrier may further limit the ability of the user to engage in spontaneous conversation.

One way to enhance these existing assistive communication technologies may be to utilize a natural language processing model such as large language model (LLM), which may improve efficiency, accuracy, and/or context-awareness through machine learning and artificial intelligence (AI) based approaches. In some implementations, an LLM may enhance the capability of an assistive communication system by enabling more advanced, context-sensitive language generation. By integrating LLM in assistive communication, a user with reduced or limited physical abilities may be able to express thoughts or ideas more easily (e.g., with reduced or minimal input), thereby improving communication outcomes.

One way to further enhance these existing assistive communication technologies may be to utilize retrieval-augmented generation (RAG) with the natural language processing model such as LLM. For example, the use of RAG with natural language processing model may enhance the capability of assistive communication system by enabling the system to dynamically adapt to various contexts while considering real-time information and/or personalized user inputs.

In some implementations, embodiments disclosed herein provide system, device, and method for assistive communication. In some embodiments, the system, device, and method for assistive communication may enable or enhance assistive communication through the integration of RAG with natural language processing model such as LLM to provide personalized and/or context-aware communication for a user. In some embodiments, the system, device, and method for assistive communication may combine real-time information retrieval and language generation to improve speed, accuracy, and/or adaptability of communication for the user. In some embodiments, the system, device, and method for assistive communication may incorporate RAG with natural language processing model such as LLM to dynamically generate adaptive, context-aware language outputs. This may enable the incorporating of real-time retrieval of relevant contextual information to guide the generative processes, thereby improving communication efficiency and/or reducing physical effort required from the user to enable the communication.

In some embodiments, the system, device, and method for assistive communication may efficiently retrieve relevant contextual information while ensuring the generation of coherent, fluent, and contextually accurate responses. In some implementations, the retrieval process may be fast and reliable, and the generative model may incorporate the retrieved content in a way that provides natural, meaningful communication for the user. In some embodiments, the system, device, and method for assistive communication may handle ambiguity in user inputs, such as incomplete or vague communication, and may provide personalized responses tailored to individual user needs and/or preferences. In some embodiments, the system, device, and method for assistive communication may operate in real-time (e.g., with minimal latency from the perspective of the user), for practical implementation in dynamic, real-world environments. This may be enabled, e.g., by balancing computational complexity of both the retrieval and generation processes in RAG. In some embodiments, the system, device, and method for assistive communication may be capable of receiving and/or integrating multimodal inputs, such as eye gaze, gestures, or environmental context, e.g., in addition to text-based inputs. In some embodiments, the system, device, and method for assistive communication may provide smooth and efficient processing of various input types/modalities while maintaining low latency.

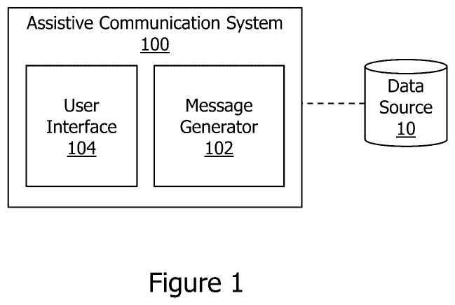

FIG. 1 shows an assistive communication system 100 in one embodiment. The assistive communication system 100 includes a message generator 102 and a user interface 104 operably connected with the message generator 102. The message generator 102 may include at least one memory and at least one processor operably connected with the at least one memory. The at least one processor may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions, and/or to process signals and/or information and/or data. The at least one memory may include: one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the at least one memory. The at least one processor and the at least one memory may be integrated, or they may be separated and operably connected. The user interface 104 may include at least one input device and at least one output device. The at least one input device may include one or more of: keyboard, keypad, mouse, stylus, microphone, voice recognition system, tactile/touch input device (e.g., touch sensitive display), image/video input device (e.g., camera), eye tracker, gaze tracker, bio-signal sensing device (e.g., EEG headset, implanted sensors), etc. The at least one output device may include one or more of: display (e.g., monitor, screen, projector, etc.), speaker, headphone, earphone, etc. The assistive communication system 100 may be implemented on a single device or on multiple devices that are operably (directly or indirectly) connected.

The assistive communication system 100 may be operably connected with a data source 10 via one or more communication links (wired or wireless). The data source 10 may store data useable by the assistive communication system 100. For example, the data source 10 may include one or more of: a structured database, an unstructured data repository, a domain-specific knowledge base, or a user history database (which may contain communication and/or interaction history of the user). In some implementations, the data source 10 may be external to the assistive communication system 100 (as illustrated in FIG. 1). In some other implementations, the data source 10 may be part of the assistive communication system 100.

The message generator 102 may be configured to receive one or more communication tokens for constructing a message for communication. In some implementations, the one or more communication tokens may each be associated with an AAC vocabulary. For example, each communication token may be one of: a digital text-based token, a digital symbol-based token, a digital audio token, etc. In some implementations, the one or more communication tokens may each be associated with a language unit corresponding to a word, a phrase, or the like. In some implementations, the one or more communication tokens may be received via or from the user interface 104.

The message generator 102 may be configured to retrieve information for constructing the message based at least in part on the one or more communication tokens received. In some implementations, the information may include one or more of: contextual information associated with the one or more communication tokens, communication history of a user, or interaction history of the user. In some implementations, the message generator 102 may retrieve the information from the data source 10.

The message generator 102 may be configured to generate an input for a natural language processing model based at least in part on the retrieved information and the one or more communication tokens. The natural language processing model may include an LLM.

The message generator 102 may be configured to obtain an output based at least in part on applying the input to the natural language processing model. The output may include one or more messages constructed based at least in part on the input. For example, the one or more messages may each include a sentence. The sentence may be, e.g., a declarative sentence (statement), an imperative sentence (command), an exclamatory sentence (exclamation), or an interrogative sentence (question). In some implementations, the output may further include one or more updated communication tokens. Each updated communication token may be associated with an AAC vocabulary.

The message generator 102 may be configured to output the one or more messages. In some implementations, the one or more messages may be output to the user interface 104. In some implementations, the message generator 102 may be configured to further output the one or more updated communication tokens. In some implementations, the one or more updated communication tokens may be output to the user interface 104.

The message generator 102 may be configured to receive a feedback associated with a utility (usefulness) of at least one of the one or more messages in response to the output of the one or more messages. For example, the feedback may be associated with a score or rating of usefulness of at least one of the one or more messages. For example, the feedback may be associated with a selection of one of the one or more messages for communication. In some implementations, the feedback may be received via or from the user interface 104. The message generator 102 may be configured to adapt (e.g., fine-tune) the natural language processing model based at least in part on the feedback.

The message generator 102 may be configured to: in response to the output of the one or more updated communication tokens, receive one or more further communication tokens (for constructing the message or a further message); retrieve further information (for constructing the message or a further message) based at least in part on the one or more further communication tokens; generate a further input for the natural language processing model based at least in part on the further retrieved information and the one or more further communication tokens; obtain a further output based at least in part on applying the further input to the natural language processing model, wherein the further output may include one or more further messages constructed based at least in part on the further input; and output the one or more further messages. The one or more further communication tokens may be received via or from the user interface 104. The further information may be retrieved from the data source 10. The further information may include one or more of: contextual information associated with the one or more further communication tokens, communication history of the user, or interaction history of the user. The one or more further messages may each include a sentence. The one or more further messages may be output to the user interface 104.

The message generator 102 may be configured to: in response to the output of the one or more further messages, receive a feedback associated with a utility of at least one of the one or more further messages. For example, the feedback may be associated with a score or rating of usefulness of at least one of the one or more further messages. For example, the feedback may be associated with a selection of one of the one or more further messages for communication. In some implementations, the feedback may be received via or from the user interface 104. The message generator 102 may be configured to adapt (e.g., fine-tune) the natural language processing model based at least in part on the feedback.

The user interface 104 may be configured to present a set of communication tokens to the user and receive a user input associated with selecting the one or more communication tokens from the set of communication tokens. The user interface 104 may be configured to output the one or more communication tokens, e.g., to the message generator 102 for constructing the message for communication.

In some implementations, the user interface 104 may be configured to provide a voice or speech output of one or more messages.

The user interface 104 may be configured to present a set of messages. The set of messages may include one or more messages generated by the message generator 102.

The user interface 104 may be configured to receive a user input associated with a utility of at least one message of the set of messages, and output a feedback associated with the utility to the message generator 102. For example, the user input may include a score or rating of usefulness of at least one of the one or more messages. For example, the user input may include a selection of one of the one or more messages for communication, and the user interface 104 may be configured to provide a voice or speech output of the selected message.

The user interface 104 may be configured to: obtain one or more updated communication tokens (e.g., from the message generator 102); present an updated set of communication tokens which includes the one or more updated communication tokens; receive a user input associated with selecting one or more communication tokens from the updated set of communication tokens; output the one or more selected communication tokens (to the message generator 102); obtain one or more further messages (e.g., from the message generator 102); present an updated set of messages that includes the one or more further messages; receive a user input associated with a utility of at least one message of the updated set of messages; and output a feedback associated with the utility to the message generator 102. For example, the user input may include a score or rating of usefulness of at least one of the one or more further messages. For example, the user input may include a selection of one of the one or more further messages for communication, and the user interface 104 may be further configured to provide a voice or speech output of the selected message.

The user interface 104 may include a multimodal user interface configured to receive user input based at least in part on gaze, speech, bioelectrical (e.g., brain) signals, or any combination thereof.

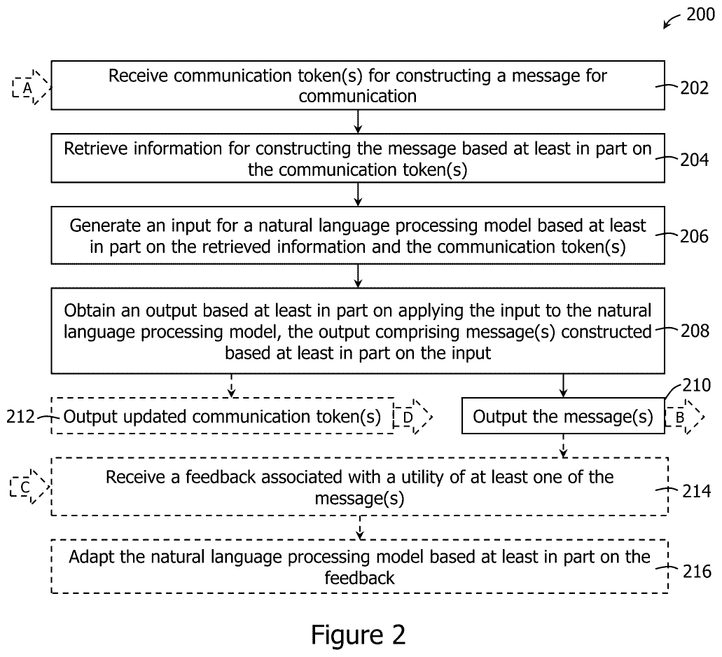

FIG. 2 illustrates a method 200 for assistive communication in one embodiment. The method 200 may be performed by an assistive communication system or an assistive communication device. For example, the method 200 may be performed by a message generator such as the message generator 102.

At 202, the method 200 includes receiving one or more communication tokens for constructing a message for communication. In some implementations, the one or more communication tokens may each be associated with an AAC vocabulary. For example, each communication token may be one of: a digital text-based token, a digital symbol-based token, a digital audio token, etc. In some implementations, the one or more communication tokens may each be associated with a language unit corresponding to a word, a phrase, or the like.

At 204, the method 200 includes retrieving information for constructing the message based at least in part on the one or more communication tokens. In some implementations, the information may include one or more of: contextual information associated with the one or more communication tokens, communication history of a user, or interaction history of the user. In some implementations, the information may be retrieved from a data source, which may include one or more of: a structured database, an unstructured data repository, a domain-specific knowledge base, or a user history database (which may contain communication and/or interaction history of the user).

At 206, the method 200 includes generating an input for a natural language processing model based at least in part on the retrieved information and the one or more communication tokens. The natural language processing model may include an LLM.

At 208, the method 200 includes obtaining an output based at least in part on applying the input to the natural language processing model. The output may include one or more messages constructed based at least in part on the input. The one or more messages may each include a sentence. The sentence may be, e.g., a declarative sentence (statement), an imperative sentence (command), an exclamatory sentence (exclamation), or an interrogative sentence (question).

The operations in 204, 206, and 208 may correspond to rag operation.

At 210, the method 200 includes outputting the one or more messages, e.g., for presenting to the user who may then provide feedback or input (e.g., selection, quality score or rating, etc.).

In some implementations, the output obtained at 208 may further include one or more updated communication tokens. For example, each updated communication token may be associated with an AAC vocabulary. In some implementations, the method 200 may further include, at 212, outputting the one or more updated communication tokens, e.g., for presenting to the user who may then provide feedback or input (e.g., selection, quality score or rating, etc.).

In some implementations, the method 200 may further include, at 214, receiving a feedback associated with a utility (usefulness) of at least one of the one or more messages. For example, the feedback may be associated with a score or rating of usefulness of at least one of the one or more further messages. In some implementations, the feedback may be associated with a selection of one of the one or more messages for communication.

In some implementations, the method 200 may further include, at 216, adapting (e.g., fine-tuning) the natural language processing model based at least in part on the feedback.

In some implementations, the method 200 may, after 210 and/or 212, return to 202 and receive one or more (further) communication tokens for constructing a message for communication. The method 200 may repeat based on the one or more (further) communication tokens. The method 200 may continue and/or repeat until the user completes the communication (e.g., dialogue) or a corresponding part of it.

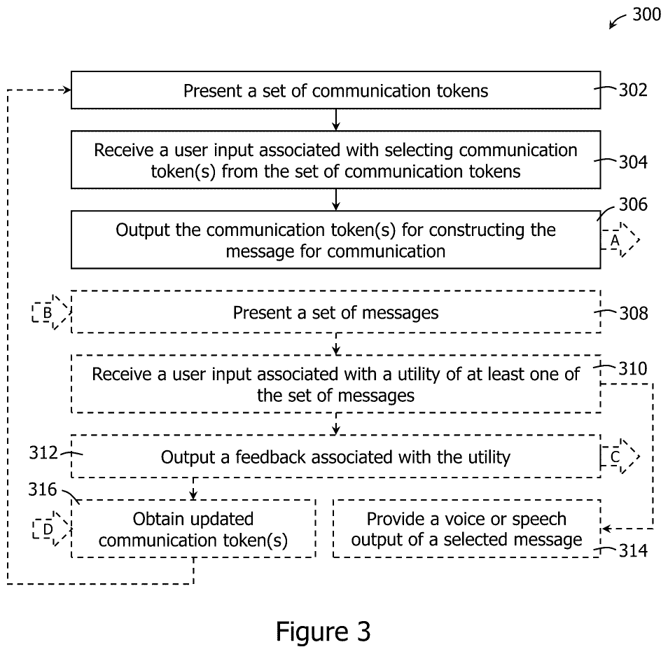

FIG. 3 illustrates a method 300 for assistive communication in one embodiment. The method 300 may be performed by an assistive communication system or an assistive communication device. For example, the method 300 may be performed by a user interface such as the user interface 104.

At 302, the method 300 includes presenting a set of communication tokens. For example, the presenting may include displaying or providing an audio output of the set of communication tokens. The set of communication tokens may include multiple communication tokens. For example, each communication token of the set of communication tokens may be associated with an AAC vocabulary. For example, each communication token of the set of communication tokens may be one of: a digital text-based token, a digital symbol-based token, a digital audio token, etc. For example, each communication token of the set of communication tokens may be associated with a language unit corresponding to a word, a phrase, or the like.

At 304, the method 300 includes receiving a user input associated with selecting one or more communication tokens from the set of communication tokens. The one or more selected communication tokens may be associated with a message that the user wants to construct for communication. The user input may be received based at least in part on gaze, speech, bioelectric (e.g., brain) signals, or any combination thereof of the user.

At 306, the method 300 includes outputting the one or more communication tokens for constructing a message for communication. For example, the one or more communication tokens may be output to a message generator.

In some implementations, the method 300 may further include, at 308, presenting a set of messages. For example, the presenting may include displaying or providing an audio output of the set of messages. The set of messages may include multiple messages. The set of messages may be constructed based at least in part on RAG using the one or more communication tokens. For example, each message of the set of messages may include a sentence. The sentence may be, e.g., a declarative sentence (statement), an imperative sentence (command), an exclamatory sentence (exclamation), or an interrogative sentence (question).

In some implementations, the method 300 may further include, at 310, receiving a user input associated with a utility of at least one message of the set of messages. In some implementations, the user input may include a score or rating of usefulness of at least one of the one or more further messages. In some implementations, the user input may include a selection of one of the one or more messages for communication. The user input may be received based at least in part on gaze, speech, bioelectric (e.g., brain) signals, or any combination thereof of the user.

In some implementations, the method 300 may further include, at 312, outputting a feedback associated with the utility. For example, the feedback may be output to an entity that provides or generates the one or more messages.

In some implementations, the method 300 may further include, at 314, providing a voice or speech output of a selected message, e.g., if the user input associated with the utility at 310 includes a selection of one of the one or more messages for communication. In some implementations, 314 may include a text-to-speech operation.

In some implementations, the method 300 may further include, at 316, obtaining one or more updated communication tokens. For example, each updated communication token may be associated with an AAC vocabulary. The method 300 may update the set of communication tokens based on the one or more updated communication tokens, and return to 302, to present a set (an updated set) of communication tokens, for selection by the user in constructing a message. The method 300 may continue and/or repeat until the user completes the communication (e.g., dialogue) or a corresponding part of it.

One skilled in the art appreciates that the methods 200, 300 are merely example implementations and that the methods 200, 300 may be modified to provide other embodiments. For example, the order of the steps or operations in 200 may be modified as long as the modification is logical to one skilled in the art. For example, the order of the steps or operations in 300 may be modified as long as the modification is logical to one skilled in the art.

In one embodiment, a method for assistive communication may include both methods 200 and 300. For example, as illustrated by arrow A in FIGS. 2 and 3, 306 in method 300 may correspond to 202 in method 200 (i.e., the communication token(s) output at 306 may be the communication token(s) output at 202). For example, as illustrated by arrow B in FIGS. 2 and 3, 210 in method 200 may correspond to 308 in method 300 (i.e., the message(s) output at 210 may be included in the set of messages at 308). For example, as illustrated by arrow C in FIGS. 2 and 3, 312 in method 300 may correspond to 214 in method 200 (i.e., the feedback output at 312 may correspond to the feedback received at 214). For example, as illustrated by arrow D in FIGS. 2 and 3, 212 in method 200 may correspond to 316 in method 300 (i.e., the updated communication token(s) output at 212 may correspond to the updated communication token(s) obtained at 316).

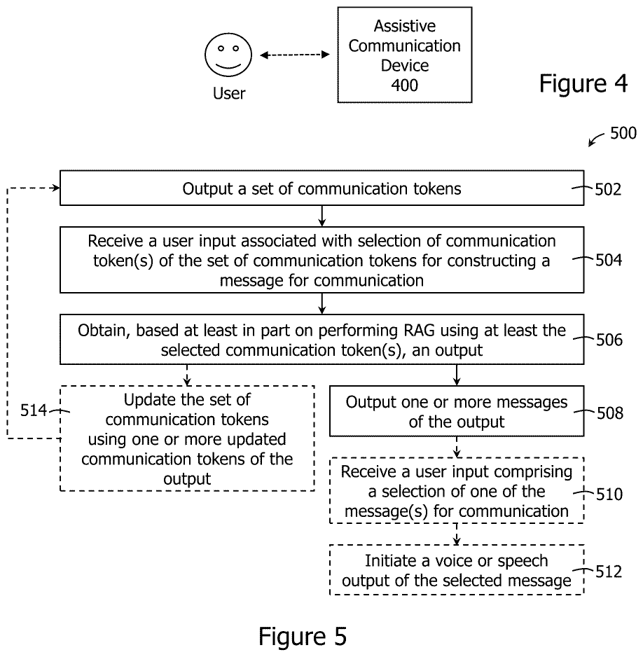

FIG. 4 shows an assistive communication device 400 in one embodiment. The assistive communication device 400 may include at least one memory and at least one processor operably connected with the at least one memory. The at least one processor may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions, and/or to process signals and/or information and/or data. The at least one memory may include: one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the at least one memory. The at least one processor and the at least one memory may be integrated, or they may be separated and operably connected. The assistive communication device 400 may further include a user interface, which may include at least one input device and at least one output device. The at least one input device may include one or more of: keyboard, keypad, mouse, stylus, microphone, voice recognition system, tactile/touch input device (e.g., touch sensitive display), image/video input device (e.g., camera), eye tracker, gaze tracker, bio-signal sensing device (e.g., EEG headset, implanted sensors), etc. The at least one output device may include one or more of: display (e.g., monitor, screen, projector, etc.), speaker, headphone, earphone, etc. The assistive communication system 100 may be implemented on a single device or on multiple devices that are operably (directly or indirectly) connected. The assistive communication device 400 may be used by a user, who may be an individual with difficulty in communication. The assistive communication device 400 may be portable or wearable by the user.

The assistive communication device 400 may be configured to output a set of communication tokens. For example, the set of communication tokens may include multiple communication tokens each associated with an AAC vocabulary. For example, each communication token of the set of communication tokens may be one of: a digital text-based token, a digital symbol-based token, a digital audio token, etc. In some implementations, each communication token of the set of communication tokens may be associated with a language unit corresponding to a word, a phrase, or the like.

The assistive communication device 400 may be configured to receive a user input associated with selection of one or more communication tokens of the set of communication tokens for constructing a message for communication. In some implementations, the assistive communication device 400 may be configured to receive the user input based at least in part on touch, gaze, speech, bioelectric signals, or any combination thereof.

The assistive communication device 400 may be configured to obtain, based at least in part on performing retrieval-augmented generation (RAG) using at least the one or more selected communication tokens, an output including one or more messages. In some implementations, the RAG may include: retrieving information for constructing the message based at least in part on the one or more selected communication tokens; generating an input for a natural language processing model based at least in part on the retrieved information and the one or more selected communication tokens; and applying the input to the natural language processing model to obtain the output. The information may include one or more of: contextual information associated with the one or more selected communication tokens, communication history of a user, or interaction history of the user. The natural language processing model may include an LLM. For example, the one or more messages may each include a sentence. The RAG may be performed at the assistive communication device 400, at a data processing system operably connected with the assistive communication device 400, or both (i.e., distributed across the assistive communication device 400 and the data processing system).

The assistive communication device 400 may be configured to output the one or more messages, for presenting the one or more messages to a user.

The assistive communication device 400 may be configured to receive a user input including a selection of one of the one or more messages for communication, and initiate a voice or speech output of the selected message. In some implementations, the assistive communication device 400 may be configured to receive the user input based at least in part on touch, gaze, speech, bioelectric signals, or any combination thereof. In some implementations, the assistive communication device 400 may be configured to perform text-to-speech conversion for the selected message.

In some implementations, the output obtained based at least in part on the RAG also includes one or more updated communication tokens. Each updated communication token may be associated with an AAC vocabulary. In these implementations, the assistive communication device 400 may be configured to update the set of communication tokens based at least in part on the one or more updated communication tokens. For example, the updated set of communication tokens may include the one or more updated communication tokens and optionally one or more previous communication tokens.

In some implementations, the assistive communication device 400 may be configured to output the updated set of communication tokens; receive a user input associated with a further selection of one or more communication tokens of the updated set of communication tokens; obtain, based at least in part on performing RAG using at least the one or more further selected communication tokens, a further output including one or more further messages; and output the one or more further messages. In some implementations, the RAG may include: retrieving further information (for constructing a/the message) based at least in part on the one or more further selected communication tokens; generating a further input for the natural language processing model based at least in part on the retrieved further information and the one or more further selected communication tokens; and applying the further input to the natural language processing model to obtain the further output. The further output may further include one or more updated communication tokens. The one or more further messages may each include a sentence. In some implementations, the assistive communication device 400 may be configured to receive the user input based at least in part on touch, gaze, speech, bioelectric signals, or any combination thereof. In some implementations, the assistive communication device 400 may be configured to receive a user input including a selection of one of the one or more further messages for communication, and initiate a voice or speech output of the selected message. In some implementations, the assistive communication device 400 may be configured to receive the user input based at least in part on touch, gaze, speech, bioelectric signals, or any combination thereof. In some implementations, the assistive communication device 400 may be configured to perform text-to-speech conversion for the selected message.

FIG. 5 illustrates a method 500 for assistive communication in one embodiment. The method 500 may be performed by an assistive communication system or an assistive communication device. For example, the method 500 may be performed by an assistive communication device such as the assistive communication device 400.

At 502, the method 500 includes outputting a set of communication tokens, for presenting the set of communication tokens to a user. For example, the set of communication tokens may include multiple communication tokens each associated with an AAC vocabulary. For example, each communication token of the set of communication tokens may be one of: a digital text-based token, a digital symbol-based token, a digital audio token, etc. For example, each communication token of the set of communication tokens may be associated with a language unit corresponding to a word, a phrase, or the like.

At 504, the method 500 includes receiving a user input associated with selection of one or more communication tokens of the set of communication tokens for constructing a message for communication. In some implementations, the user input may be received based at least in part on touch, gaze, speech, bioelectric signals, or any combination thereof. The one or more selected communication tokens may be associated with a message that the user wants to construct for communication.

At 506, the method 500 includes obtaining an output based at least in part on performing RAG using at least the selected one or more communication tokens. The output may include one or more messages constructed. In some implementations, the RAG may include: retrieving information for constructing the message based at least in part on the one or more selected communication tokens; generating an input for a natural language processing model based at least in part on the retrieved information and the one or more selected communication tokens; and applying the input to the natural language processing model to obtain the output. The information may include one or more of: contextual information associated with the one or more selected communication tokens, communication history of a user, or interaction history of the user. The natural language processing model may include an LLM. For example, the one or more messages may each include a sentence. In some implementations, the output may further include one or more updated communication tokens.

At 508, the method 500 includes outputting the one or more messages of the output obtained in 506, for presenting the one or more messages to a user.

In some implementations, the method 500 may further include, at 510, receiving a user input including a selection of one of the one or more messages for communication. In some implementations, the user input may be received based at least in part on touch, gaze, speech, bioelectric signals, or any combination thereof.

In some implementations, the method 500 may further include, at 512, initiating a voice or speech output of the selected message. For example, text-to-speech conversion may be performed for the selected message.

In some implementations, the method 500 may further include, at 514, updating the set of communication tokens using one or more updated communication tokens of the output obtained in 506, to facilitate construction of the message (if the previously constructed message(s) are not useful) or a new message (e.g., another dialogue). The method 500 may return to 502 and output the set of (updated) communication tokens.

The method 500 may continue and/or repeat until the user completes the communication (e.g., dialogue) or a corresponding part of it.

One skilled in the art appreciates that the method 500 is merely an example implementation and that method 500 may be modified to provide other embodiments. For example, the order of the steps or operations in 500 may be modified as long as the modification is logical to one skilled in the art.

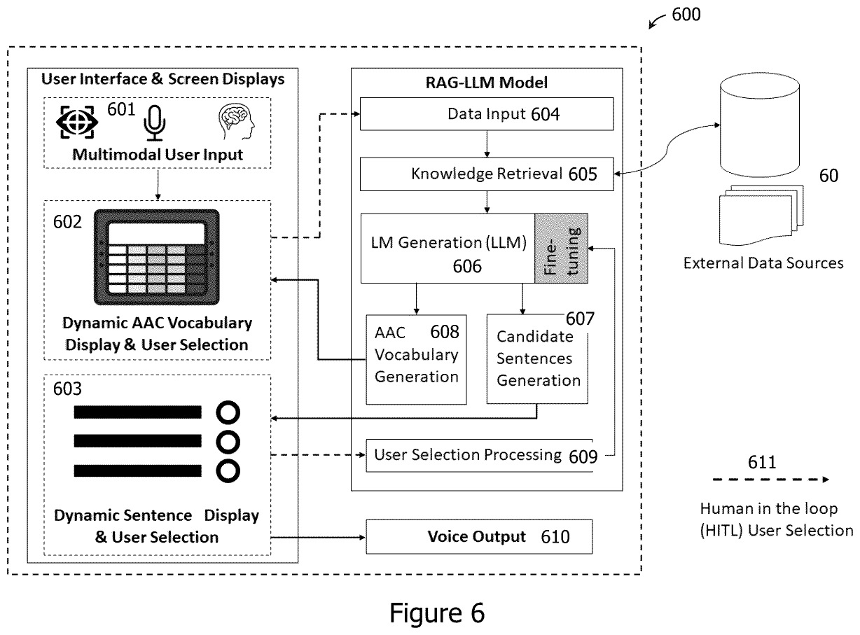

FIG. 6 shows a system 600 for assistive communication in one embodiment. For example, the system 600 may be considered as an example implementation of the assistive communication system 100 of FIG. 1 or an example implementation of the assistive communication device 400 of FIG. 4.

In this embodiment, the system 600 includes an AAC system utilizing a retrieval-augmented generation large language model (RAG-LLM). The system 600 may assist individuals with speech, motor, or cognitive impairments by generating dynamic vocabulary suggestions and candidate sentences, thereby enabling efficient and contextually relevant communication. The system 600 may enable dynamic, context-aware communication. The system 600 may integrate multimodal user inputs, such as eye-tracking, speech-to-text, or brain-computer interface, to provide a seamless interaction experience. The system 600 generally includes (1) a multimodal user interface for vocabulary and sentence selection, (2) an RAG-LLM model for generating personalized vocabulary and sentence suggestions based on real-time input and external data sources, and (3) a voice output for converting text into natural-sounding speech. The integration of external data sources, such as structured databases or user interaction history, may enable the system 600 to adapt to the communication needs of the user. The system 600 further includes a human-in-the-loop (HITL) mechanism, which may enable real-time feedback to refine generated content, thereby enhancing personalization and accuracy over time. The multimodal user input and the real-time fine-tuning mechanisms may improve user interaction and response accuracy. The system 600 may improve communication efficiency and effectiveness. The system 600 may provide a more adaptive and personalized communication experience to individuals with communication (e.g., speech) impairments.

FIG. 6 schematically shows the system 600 with user interface and screen displays and a RAG-LLM model, and external data sources 60 operably connected with the system 600. The various components of the system 600 and the external data sources 60 may interact to enable multimodal user input, dynamic vocabulary and sentence generation, and seamless communication via AI-driven assistive technique.

In some implementations, the user interface and screen displays enable user interaction with the system 600 through multimodal inputs and dynamically generated communication options. As shown in FIG. 6, the user interface and screen displays include a multimodal user input module 601, a dynamic AAC vocabulary display and user selection module 602, and a dynamic sentence display and user selection module 603.

The multimodal user input module 601 may support multiple input modalities, including eye-tracking, speech-to-text, and brain-computer interface (e.g., in addition to touch or text), thus allowing users with varying abilities to interact with the system 600 seamlessly. These input methods may enable users to select AAC vocabulary tokens or construct sentences for communication.

The dynamic AAC vocabulary display and user selection module 602 may present a grid-based vocabulary selection interface, via which users can choose symbols, words, pictograms, or like vocabulary representations. The vocabulary set may be dynamically adapted (updated) based on contextual information, previous interactions, and real-time user preferences.

The dynamic sentence display and user selection module 603 may, based on the selected vocabulary tokens, generate candidate sentences using the RAG-LLM model and display the sentences. Users may select one of the constructed sentences for use in communication. The constructed sentences may be formulated based on retrieved knowledge and user communication history. Based on the selection of the user, the chosen vocabulary or sentence may be transmitted to the RAG-LLM model for further processing and refinement (e.g., reinforcement).

In some implementations, the RAG-LLM model may enable intelligent language generation by integrating retrieval-based contextualization with large-scale language modeling. As shown in FIG. 6, the RAG-LLM model includes a data input module 604, a knowledge retrieval module 605, a LLM module 606, a candidate sentence generation module 607, a AAC vocabulary generation module 608, and a user selection processing module 609.

The data input module 604 may receive or obtain user input from the user interface and screen displays and optionally external data sources. This may allow the system 600 to personalize predictions based on user history and contextual information.

The knowledge retrieval module 605 may include a retrieval mechanism arranged to query external data sources to extract relevant contextual information. This may enhance the accuracy and coherence of generated vocabulary and sentence suggestions.

The LLM module 606 may include an LLM, such as a fine-tuned LLM, arranged to process user input and retrieved knowledge to generate vocabulary suggestions and sentence completions tailored to the communication needs of the user.

The candidate sentence generation module 607 may perform linguistic and contextual analysis and may formulate possible sentence constructions, to better align the candidate sentences with the intent of the user and the retrieved information.

The AAC vocabulary generation module 608 may dynamically generate a tailored vocabulary set, incorporating user preferences and retrieved knowledge, to provide an adaptive and personalized communication experience.

The user selection processing module 609 may interpret the vocabulary or sentence selected by the user and prepare the selected vocabulary or sentence for further processing. The further processing may include reinforcement learning for improved future suggestions (sentence/vocabulary generation) and integration with voice output module 610.

To enhance the retrieval-augmented language generation process, the system 600 may be operably connected with the external data sources 60. These data sources 60 may provide critical contextual information, ensuring the generated vocabulary and sentences are relevant, personalized, and contextually appropriate.

The external data sources 60 may include structured databases, unstructured data repositories, prior user interactions, domain-specific knowledge bases, real-time web or API feeds, or any combinations thereof.

The structured databases may contain well-organized, predefined data formats such as relational databases, ontologies, and taxonomies. Structured data may help in precise retrieval of information related to specific domains, predefined vocabulary sets, or context-specific terminology.

The unstructured data repositories may include text corpora, articles, open-access repositories, and conversational logs. These data sources may enhance the adaptability of the language model by incorporating diverse linguistic patterns and context-aware retrieval.

In respect of prior user interactions, the system 600 may continuously learn from previous user interactions, preferences, and selections. By analyzing historical data, the system 600 may refine its vocabulary suggestions and sentence generation to improve personalization over time.

In respect of domain-specific knowledge bases, the model may integrate specialized knowledge repositories relevant to the communication needs of the user. These may include, e.g., medical knowledge bases for healthcare communication, academic sources for educational settings, and industry-specific terminology databases.

In respect of real-time web or API feeds, the system 600 may retrieve live information, e.g., in real time, from external APIs, such as news sources, weather updates, or public datasets, allowing for dynamic and up-to-date content generation.

The utilization of the various data sources 60 may ensure that the system 600 can remain flexible, continuously updated, and context-aware, thereby improving the quality of generated content and enhancing the communication experience of the user.

As shown in FIG. 6, the system 600 further includes a voice output module 610. The voice output module 610 may convert the finalized (user-selected) sentence into synthesized speech, thereby enabling seamless auditory communication. This module 610 may help individuals with speech and language impairments express themselves effectively. For example, the voice output module 610 may perform text-to-speech conversion, for transforming the selected text into natural-sounding speech. For example, the voice output module 610 may provide multilingual support, e.g., for generating speech output in different languages and dialects based on user preferences. For example, the voice output module 610 may include customization options that allow users to adjust voice parameters such as pitch, speed, and volume for a personalized experience. In some implementations, the voice output module 610 may enhance accessibility by providing an intuitive auditory communication means, thereby enabling real-time interaction in various settings.

As shown in FIG. 6, the system 600 further includes a human-in-the-loop (HITL) mechanism 611. The HITL mechanism 611 may ensure high accuracy, personalization, and adaptability to individual user preferences. This may allow users to interact with the system 600 in a way that can enhance the outputs of the system 600 by enabling real-time adjustments. In some implementations, the HITL mechanism 611 may facilitate the dynamic refinement of system-generated suggestions based on user feedback before the final output is produced. The iterative nature of this process may improve, continuously or over time, the quality of interactions by aligning the responses of the system 600 more closely with the unique needs and communication style of the user. The HITL mechanism 611 may also provide a feedback loop that can adapt over time, by learning from user input to offer more relevant and accurate suggestions. In some implementations, the HITL mechanism 611 may enhance communication efficiency. In some implementations, the HITL mechanism 611 may also allow the user to maintain control over the decision-making process of the system 600. This may be useful for achieving a personalized and effective user experience.

In some implementations, the user interface and screen displays and the voice output module 610 may correspond to a user interface. In some implementations, the RAG-LLM model module may correspond to a message (e.g., sentence/vocabulary) generator.

The integration of various components of the system 600 may provide a robust, intelligent AAC system that can facilitate effective communication, e.g., for individuals with speech or physical impairments.

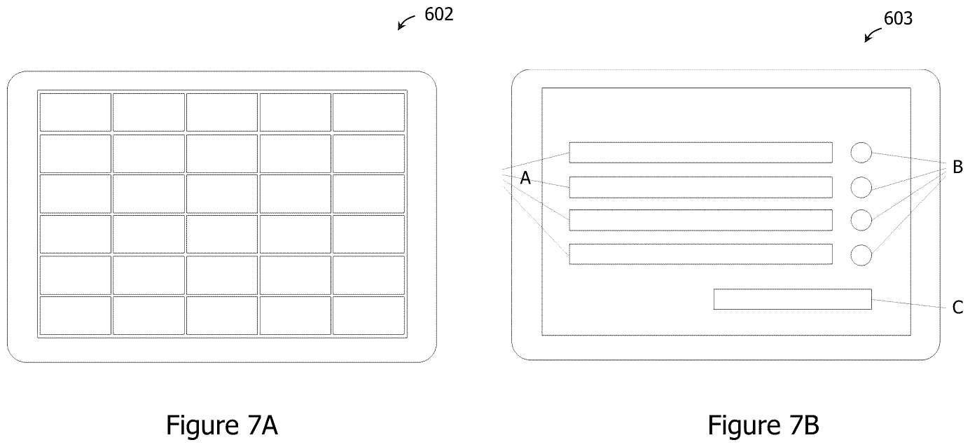

FIG. 7A illustrates an example vocabulary selection interface of the dynamic AAC vocabulary display and user selection module 602 in one embodiment. As shown in FIG. 7A, the interface includes a grid-based layout arranged to display AAC vocabulary (such as words, pictograms, tokens, etc.). The user may interact with the grid-based layout, e.g., to select one or more of the AAC vocabulary. The AAC vocabulary may be dynamically generated and updated using RAG-LLM and displayed to the user, to provide contextually relevant options based on prior communication.

FIG. 7B illustrates an example sentence construction interface of the dynamic sentence display and user selection module 603 in one embodiment. In some implementations, after the user selects the AAC vocabulary, the system 600 may retrieve and construct candidate sentences, which may then be selected by the user for use in communication. The system 600 may suggest and display multiple structured responses A (FIG. 7B). Each response may be accompanied by a selection button B (FIG. 7B), which may allow the user to finalize their choice with minimal effort. A further button C (FIG. 7B), which corresponds to “one of the above”, may be selected by the user. If the button C is selected, a new set of sentences may be generated again for further selection by the user. The dynamic input selection may eliminate reliance on a static vocabulary set, allowing continuous adaptation based on user behavior and context. The selected AAC vocabulary (e.g., words, pictograms) are forwarded for data preprocessing and contextualization.

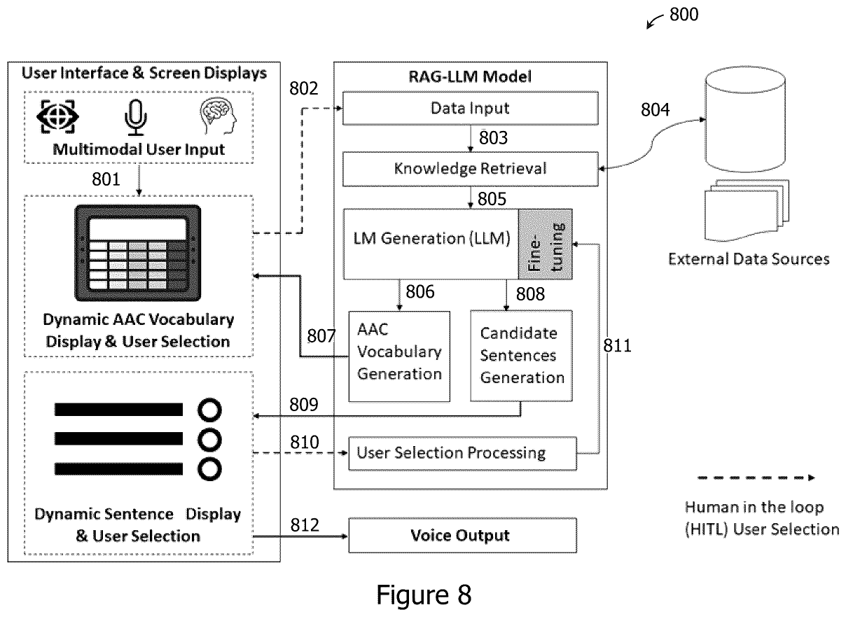

FIG. 8 illustrates an example operation 800 of the system 600 of FIG. 6 in one embodiment.

As illustrated in FIG. 8, the operation 800 may generally follow a structured flow to facilitate efficient user communication using multimodal inputs, intelligent language modelling, and external knowledge retrieval.

The operation 800 includes, at 801, user input processing. The process may be initiated when the user interacts with the multimodal user input module 601. For example, the user may select AAC vocabulary using eye-tracking, speech-to-text, or brain-computer interface. The selected input may be provided to the dynamic AAC vocabulary display and user selection module 602 for processing.

The operation 800 includes, at 802, vocabulary selection and system processing. The dynamic AAC vocabulary display and user selection module 602 may present vocabulary options based on user interaction. After a selection is made, the selection (the selected AAC vocabulary) may be provided to the data input module 604 of the RAG-LLM model for further processing.

The operation 800 includes, at 803, knowledge retrieval initiation. The data input module 604 may receive the selected vocabulary and trigger the knowledge retrieval mechanism of the knowledge retrieval module 605, which may search for relevant contextual information.

The operation 800 includes, at 804, external data querying. The knowledge retrieval module 605 may query one or more data sources, which may include structured databases, unstructured data repositories, prior user interactions, and/or domain-specific knowledge bases, to extract relevant data.

The operation 800 includes, at 805, applying retrieved data for language processing. The retrieved information may be provided to the LLM module 606. The LLM in the LLM module 606 may refine vocabulary and sentence generation using contextualized data.

The operation 800 includes, at 806, vocabulary generation. The AAC vocabulary generation module 608 may use the processed data to generate an updated vocabulary set, to facilitate user-adaptive communication.

The operation 800 includes, at 807, updated vocabulary display. The newly generated AAC vocabulary set may be provided to the dynamic AAC vocabulary display and user selection module 602. The user may refine the selection of the AAC vocabulary.

The operation 800 includes, at 808, candidate sentences generation. The LLM module may generate sentence suggestions tailored to the communication needs of the user and provides them to the candidate sentence generation module 607.

The operation 800 includes, at 809, sentence suggestions display. The candidate sentences may be provided to the dynamic sentence display and user selection module 603. The user may then review and select the most appropriate sentence (the sentence that best expresses the intent or thought of the user) via the dynamic sentence display and user selection module 603.

The operation 800 includes, at 810, user selection processing. After the user selects a sentence, the selected sentence may be processed by the user selection processing module 609. This may ensure that the choice of sentences/vocabulary may be optimized for future predictions.

The operation 800 includes, at 811, fine-tuning the LLM with user selection data. The selected vocabulary and sentence data may be provided to the LLM module 606 for fine-tuning. This may improve future language predictions based on user interactions.

The operation 800 includes, at 812, speech output generation. The selected sentence may be provided to the voice output module 610. The voice output module 610 may convert the selected sentence into synthesized speech. This may enable effective communication of the intent or thought of the user.

The system 600 may be used for various applications. For example, the system 600 may enable individuals with physical, cognitive, or communication limitations to interact with others more effectively in various settings (e.g., academic settings, everyday settings).

In one example, the system 600 may be used for an application of classroom participation for student with severe physical limitation. In this example, a student with severe physical disabilities, such as paralysis or motor impairments, may utilize the system 600 to actively participate in classroom discussions. The system 600 may enable communication through multimodal user input, dynamic vocabulary generation, and intelligent sentence formulation.

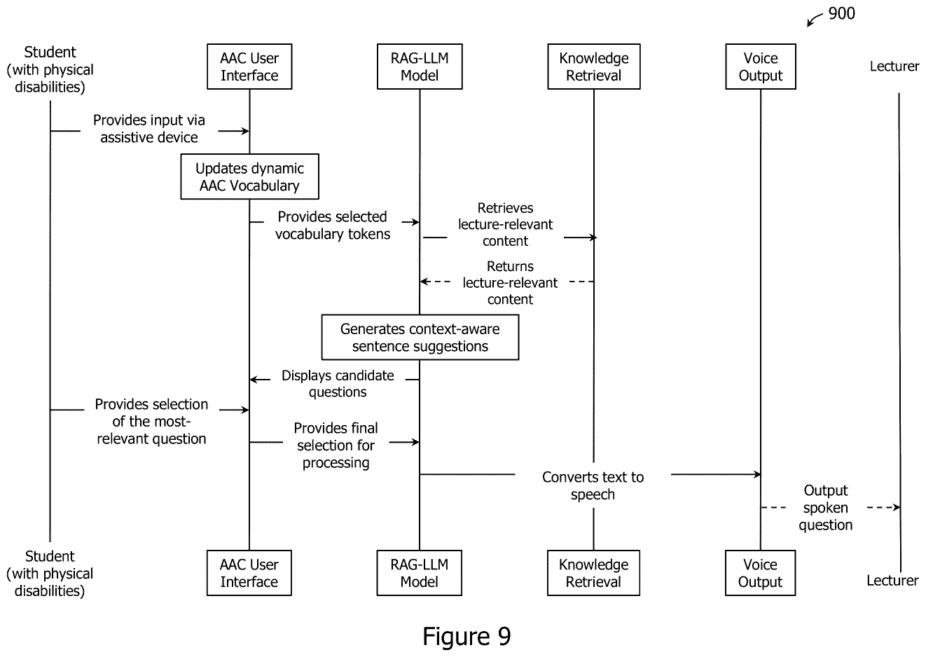

FIG. 9 shows example operations 900 performed in this application. The operations 900 may generally include:
(1) User input: The student may provide an input using an assistive device, such as an eye-tracker, brain-computer interface, or speech-to-text system.
(2) Dynamic AAC vocabulary display and selection: The system 600 may present a grid-based interface (such as that of FIG. 7A) that displays words, pictograms, or like vocabulary tokens relevant to the lecture context. The vocabulary may be dynamically adapted (updated) and displayed) based on past interactions and lecture content.
(3) Data input to RAG-LLM: The selected vocabulary tokens may be provided to the RAG-LLM for processing.
(4) Knowledge retrieval: The system 600 may query external data sources, including lecture notes, textbooks, and online academic repositories, to enhance context understanding.
(5) LLM-based generation: The LLM may generate possible sentence completions based on retrieved knowledge and user intent.
(6) Candidate sentences display and selection: The system 600 may present a list of sentence suggestions that may align with the intent of the student. The student may select the most appropriate sentence.
(7) User selection processing: The chosen sentence may be analyzed, and feedback may be incorporated to improve future recommendations.
(8) Voice output: The finalized (selected) sentence may be converted into synthesized speech/This may allow the student to verbally participate in the classroom discussion.
(9) Adaptive learning: The system 600 may refine future vocabulary and sentence suggestions based on user interactions, thereby improving personalization and efficiency.

In this example application, the structured approach associated with the operation of the system 600 may allow students with severe physical limitations to engage in classroom discussions efficiently, thereby promoting inclusive and meaningful participation.

In another example, the system 600 may be used for an application of workplace communication for individuals with speech impairments. In this example, an employee with a speech impairment may use the system 600 to facilitate workplace communication. The system 600 may enable seamless interaction with colleagues and supervisors during meetings, presentations, and daily work-related discussions.

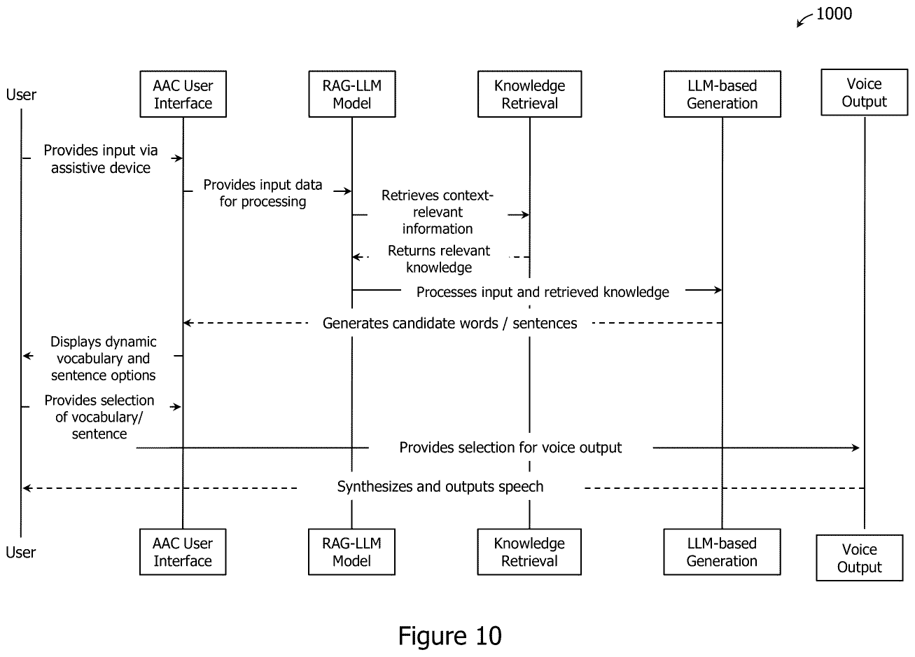

FIG. 10 shows example operations 1000 performed in this application. The operations may generally include:
(1) User input: The employee may provide input using an eye tracker, speech-to-text system, or a brain-computer interface. The input may allow the system 600 to determine the intent and communication needs of the user.
(2) Dynamic AAC vocabulary display and user selection: The system 600 may generate a personalized vocabulary set based on the role and prior conversations of the employee and context. The employee may select relevant vocabulary tokens to construct a message.
(3) Data input to RAG-LLM: The selected vocabulary tokens may be processed and used as input for the RAG-LLM model.
(4) Knowledge retrieval: The system may retrieve relevant workplace information, such as meeting notes, project documentation, and past communications, to promote contextual relevance.
(5) LLM-based generation: Based on the retrieved knowledge and user input, the system 600 may generate potential sentence completions that may align with workplace discussions.
(6) Candidate sentences generation: The system 600 may formulate multiple candidate sentences that the employee can use to communicate effectively.
(7) Dynamic sentence display and user selection: The generated candidate sentences may be displayed. The employee may review and select the most appropriate response (e.g., sentence).
(8) User selection processing: The selected response (e.g., sentence) may be processed, and the system 600 may refine its future suggestions based on the selection or selection patterns of the employee.
(9) Voice output: The finalized (selected) sentence may be converted into synthesized speech, to allow the employee to communicate verbally with colleagues in meetings or discussions.
(10) HITL feedback: The system 600 may incorporate real-time user feedback, to continuously improve and tailor communication options based on evolving needs and preferences of the employee.

In this example application, the system 600 may enhance workplace accessibility by facilitating individuals with speech impairments to actively engage in professional environments. The system 600 may enable fluid and meaningful workplace interactions by integrating various features such as personalized vocabulary, real-time knowledge retrieval, and multimodal input methods.

In another example, the system 600 may be used for an application of daily social interaction for individuals with autism spectrum disorder (ASD). In this example, an individual with ASD may attend a social gathering and is struggling with initiating or maintaining conversations. To enhance the communication abilities, the individual may use the system 600, which may provide real-time, context-aware vocabulary suggestions and sentence completions. As the conversation progresses, the system 600 may retrieve relevant phrases based on prior interactions and social context, thereby enabling the individual to construct appropriate responses.

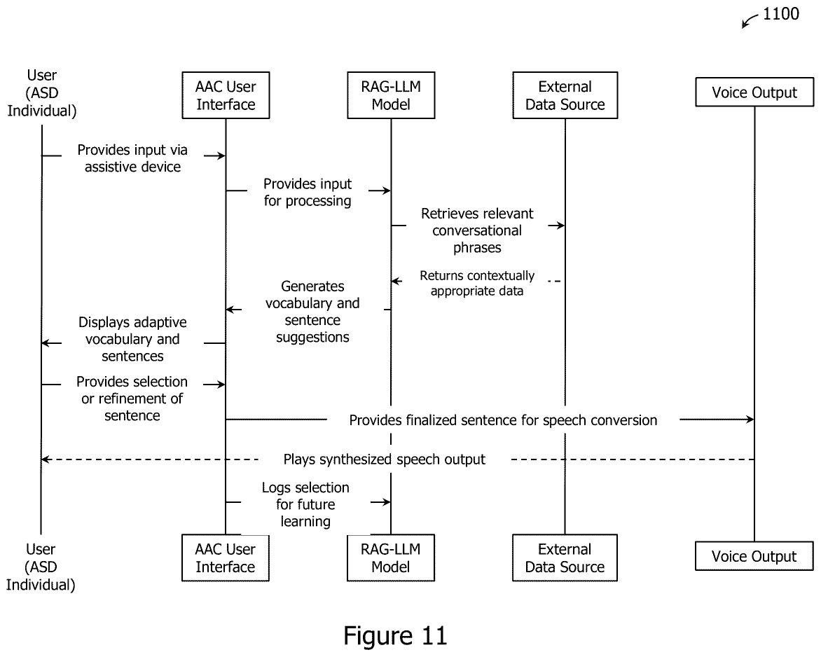

FIG. 11 shows example operations 1100 performed in this application. The operations 1100 may generally include:
(1) User input: A user with ASD may be in a social setting, such as a café with friends, and wants to participate in a conversation. The user may provide input via an eye-tracking device, speech-to-text system, or touchscreen selection to express an intent.
(2) Dynamic AAC vocabulary display: The system 600 may generate a personalized vocabulary set based on the previous interactions of the user, the current environment, and the conversational history of the user. The words and phrases displayed may be dynamically adapted (updated) to the ongoing discussion.
(3) Context-aware sentence generation: The system 600 may use the RAG-LLM model to retrieve relevant conversational phrases and may generate sentence suggestions aligned with the social context. For example, if the conversation is about a recent movie, the system may present options (sentences) such as:
   “I watched that movie too! My favorite part was . . . ”
   “That sounds interesting! Can you tell me more about it?”
(4) User selection and personalization: The user may select a suitable sentence from the displayed options (sentences) or may refine one or more of them by selecting alternative words and phrases. The system 600 may learn from the selections of the user to improve future suggestions.
(5) Voice output for seamless interaction: After the user finalizes (selects) a sentence, the system 600 may convert the text of the sentence into speech using a text-to-speech engine. The generated speech may be natural-sounding and may facilitate smooth communication in real-time.
(6) Continuous learning and adaptation: The system 600 may log/record user selections and conversation patterns, and may refine future vocabulary and sentence predictions to align with the communication style and preferences of the user.

In this example application, the system 600 may support individuals with ASD in daily social interactions by providing real-time, contextually relevant communication assistance. The system 600 may enhance confidence in social participation, enabling individuals to engage more effectively in conversations in various settings.

Some embodiments may provide an AAC system configured to utilize RAG-LLM to facilitate effective communication for individuals, in particular individuals with speech, physical, or cognitive impairments. In some implementations, the system may include a multimodal user interface operable to support various input methods, such as eye tracking, speech-to-text, and brain-computer interface, thus enabling users with different abilities to interact with the system seamlessly. In some implementations, the system may dynamically generate context-aware vocabulary suggestions and sentence completions through an intelligent language model that can integrate real-time user input with external data sources. In some implementations, the system may leverage knowledge retrieval and large-scale language modeling. The system may personalize communication options, thereby ensuring relevance to the intent and past interactions of the user. In some implementations, the system may include a HITL mechanism operable to allow iterative refinement of generated content, thereby improving accuracy and adaptability over time. In some implementations, the system may further include a voice output module operable to convert selected text into natural-sounding speech, thus enabling auditory communication. Some embodiments may provide an adaptive, personalized, and real-time AAC technique or tool that may be used to enhance various interactions (e.g., social, academic, or professional interactions) for users with communication difficulties.

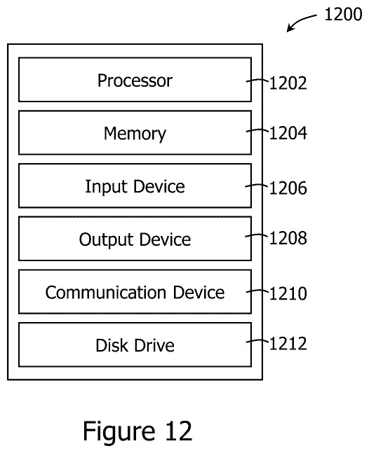

FIG. 12 shows a system 1200 for assistive communication in one embodiment. For example, the system 1200 can be used to implement the assistive communication system 100. For example, the system 1200 can be used to implement the data source 10. For example, the system 1200 can be used to implement the assistive communication device 400. For example, the system 1200 can be used to implement the method 200, the method 300, and/or the method 500. For example, the system 1200 can be used to implement the system 600. For example, the system 1200 can be used to implement the data source 60.

The system 1200 may include suitable components necessary to receive, store, and execute appropriate computer instructions, commands, and/or codes. In some implementations, the system 1200 may include at least one processor 1202 and at least one memory 1204. The at least one processor 1202 may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions, and/or to process signals and/or information and/or data. In some implementations, the at least one memory 1204 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the at least one memory 1204. For example, computer instructions for performing the steps or operations of one or more of the methods 200, 300, 500 may be stored in the at least one memory 1204. For example, computer instructions for performing the steps or operations of one or more of the operations 800, 900, 1000, 1100 may be stored in the at least one memory 1204. The at least one processor 1202 and the at least one memory 1204 may be integrated, or they may be separated and operably connected.

In some implementations, the system 1200 may further include at least one input device 1206. Examples of the at least one input device 1206 may include one or more of: keyboard, keypad, mouse, stylus, image scanner, microphone, voice recognition system, tactile/touch input device (e.g., touch sensitive display), image/video input device (e.g., camera), eye tracker, gaze tracker, bio-signal sensing device (e.g., EEG headset, implanted sensors), etc. The at least one input device 1206 may be configured to receive user input.

In some implementations, the system 1200 may further include at least one output device 1208. Examples of the at least one output device 1208 may include one or more of: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The at least one output device 1208 may be configured to present information to the user.

In some implementations, the system 1200 may further include at least one disk drive 1212. Examples of the at least one disk drive 1212 may include one or more of: solid state drive, hard disk drive, optical drive, flash drive, magnetic tape drive, etc. A suitable operating system may be installed in the system 1200, e.g., on the at least one disk drive 1212 or in the at least one memory 1204. The at least one memory 1204 and the disk drive 1212 may be operated by the at least one processor 1202.

In some implementations, the system 1200 may further include at least one communication device 1210 for establishing one or more communication links with one or more other computing devices, such as servers, database, repositories, personal computers, terminals, tablets, phones, watches, IoT devices, or other computing devices. The at least one communication device 1210 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, 6G, etc.) transceiver, an optical port, an infrared port, a USB connection, or other wired or wireless communication interface. Transceiver may be implemented by one or more devices (integrated transmitter(s) and receiver(s), separate transmitter(s) and receiver(s), etc.). The communication link(s) may be wired or wireless for communicating commands, instructions, information and/or data.

In some implementations, the at least one processor 1202, the at least one memory 1204 (optionally the at least one input device 1206, the at least one output device 1208, the at least one communication device 1210 and the at least one disk drive 1212, if present) may be operably connected with each other, directly or indirectly, through a bus, a Peripheral Component Interconnect (PCI), such as PCI Express, a Universal Serial Bus (USB), an optical bus, or other like connection means or structure. In some implementations, at least some of these components may be connected wirelessly, e.g., through a network, such as the Internet or a cloud computing network. One skilled in the art appreciates that the system 1200 is merely an example and that in other embodiments the system 1200 can have a different configuration (e.g., with additional component(s), fewer component(s), alternative component(s)).

In some implementations, embodiments disclosed herein may be implemented as an application programming interface (API) or as a series of libraries for use by a developer or can be included within another software application, such as a terminal or computer operating system or a computing device operating system. Generally, as program modules include routines, programs, objects, components, and data files assisting in the performance of particular function, one skilled in the art will understand that the functionality of the software application may be distributed across a number of routines, objects, and/or components to achieve the same functionality desired herein.

It will also be appreciated that where the methods, devices, and systems disclosed herein may be either wholly implemented by computing system or partly implemented by computing systems, then any appropriate computing system architecture may be utilized. Depending on implementations, this may include stand-alone computers, network computers, dedicated or non-dedicated hardware devices. As used herein, terms such as “computing system”, “computing device”, or the like are intended to include any appropriate arrangement of computer or information processing hardware capable of implementing the function described.

The system, device, and method for assistive communication disclosed herein may be used for various applications. For example, by integrating RAG with natural language processing model such as LLM, the system, device, and method for assistive communication disclosed herein may enhance AAC such as for individuals with CCN. In some implementations, the system, device, and method for assistive communication disclosed herein may provide personalized, context-aware communication. The system, device, and method for assistive communication disclosed herein may dynamically augment communication in real-time and may adapt to the environment of the user.

In one example, the system, device, and method for assistive communication disclosed herein may be used for healthcare applications, e.g., in rehabilitation centers and hospitals. In some implementations, the system, device, and method may assist patients with speech or neurological impairments to express themselves, thus may enable better communication between the patients and healthcare professionals and may improve patient outcomes. In some implementations, by reducing the cognitive load and physical effort required from the users, the system, device, and method may facilitate faster recovery and may enhance overall healthcare experience for both the patients and the caregivers.

In one example, the system, device, and method for assistive communication disclosed herein may be used for education applications, e.g., in schools and universities. In some implementations, the system, device, and method may help students with disabilities, such as those with ASD or cerebral palsy, to participate more effectively in classroom activities. In some implementations, the system, device, and method may enable real-time communication during lessons, discussions, and presentations, hence allowing students with disabilities to ask questions, express ideas, and engage with peers and teachers. In some implementations, this may lead to improved educational outcomes.

In one example, the system, device, and method for assistive communication disclosed herein may be used in workspace, e.g., in work/professional environments. In some implementations, the system, device, and method may enhance communication for individuals with speech or motor impairments, thus facilitating more effective engagement in meetings, presentations, and workplace tasks. In some implementations, the system, device, and method may provide an efficient and context-sensitive communication tool, which may improve collaboration, reduce misunderstandings, and/or enhance productivity in both traditional and remote work settings.

In one example, the system, device, and method for assistive communication disclosed herein may be used generally as assistive technology. In some implementations, the system, device, and method may be integrated into various assistive technology devices, thus may offer a scalable solution for individuals with complex communication needs in both personal and professional settings. The system, device, and method may be used at home, in social interactions, or for public engagement, and may provide a flexible communication solution that can adapt to different user preferences and contexts.

One skilled in the art would appreciate that the applications of the system, device, and method for assistive communication disclosed herein may not be limited to the example applications specifically disclosed.

One skilled in the art would further appreciate that variations and/or modifications may be made to the disclosed embodiments to provide other embodiments. The disclosed embodiments should therefore be considered in all respects as illustrative, not restrictive.

In some embodiments, the system, device, and method for assistive communication may be used by an individual with speech or communication impairments for various purposes. In some embodiments, the system, device, and method for assistive communication may be used by a healthy individual (e.g., an individual without speech or communication impairments) for various purposes. In some embodiments, the system, device, and method for assistive communication may allow the user to communicate with others, e.g., face-to-face or remotely (e.g., via email, messaging, or phone call).

1. A system for assistive communication comprising:
a message generator comprising at least one memory and at least one processor operably connected with the at least one memory, wherein the message generator is configured to:
receive one or more communication tokens for constructing a message for communication;
retrieve information for constructing the message based at least in part on the one or more communication tokens;
generate an input for a natural language processing model based at least in part on the retrieved information and the one or more communication tokens;
obtain an output based at least in part on applying the input to the natural language processing model, the output comprises one or more messages constructed based at least in part on the input; and
output the one or more messages.

2. The system of claim 1, wherein the one or more communication tokens are each associated with an augmentative and alternative communication (AAC) vocabulary.

3. The system of claim 1, wherein each of the one or more communication tokens is associated with a language unit corresponding to a word or a phrase.

4. The system of claim 3, wherein the information comprises one or more of:
contextual information associated with the one or more communication tokens;
communication history of a user; or interaction history of the user.

5. The system of claim 4, wherein the message generator is configured to retrieve the information from a data source that comprises one or more of: a structured database, an unstructured data repository, a domain-specific knowledge base, or a user history database.

6. The system of claim 5, wherein the natural language processing model comprises a large language model (LLM).

7. The system of claim 6, wherein the one or more messages each comprises a sentence.

8. The system of claim 7, wherein the message generator is configured to:
in response to the output of the one or more messages, receive a feedback associated with a utility of at least one of the one or more messages; and
adapt the natural language processing model based at least in part on the feedback.

9. The system of claim 8, wherein the feedback is associated with a selection of one of the one or more messages for communication.

10. The system of claim 1,
wherein the output further comprises one or more updated communication tokens; and
wherein the message generator is configured to:
output the one or more updated communication tokens.

11. The system of claim 10, wherein the message generator is configured to:
in response to the output of the one or more updated communication tokens, receive one or more further communication tokens;
retrieve further information based at least in part on the one or more further communication tokens;
generate a further input for the natural language processing model based at least in part on the further retrieved information and the one or more further communication tokens;
obtain a further output based at least in part on applying the further input to the natural language processing model, wherein the further output comprises one or more further messages constructed based at least in part on the further input; and
output the one or more further messages.

12. The system of claim 11, wherein the message generator is configured to:
in response to the output of the one or more further messages, receive a feedback associated with a utility of at least one of the one or more further messages; and
adapt the natural language processing model based at least in part on the feedback.

13. The system of claim 12, further comprising a user interface operably connected with the message generator, wherein the user interface is configured to:
present a set of communication tokens which comprises the one or more communication tokens;
receive a user input associated with selecting the one or more communication tokens from the set of communication tokens; and
output the one or more communication tokens to the message generator for constructing the message for communication.

14. The system of claim 13, wherein the user interface is configured to provide a voice or speech output of one or more messages.

15. The system of claim 14, wherein the user interface is further configured to:
present a set of messages which comprises the one or more messages;
receive a user input associated with a utility of at least one message of the set of messages; and
output a feedback associated with the utility to the message generator.

16. The system of claim 15,
wherein the user input comprises a selection of one of the one or more messages for communication;
wherein the user interface is further configured to:
provide a voice or speech output of the selected message.

17. The system of claim 15, wherein the user interface is further configured to:
obtain one or more updated communication tokens;
present an updated set of communication tokens which comprises the one or more updated communication tokens;
receive a user input associated with selecting one or more communication tokens from the updated set of communication tokens;
output the one or more selected communication tokens to the message generator for constructing the message for communication;
obtain one or more further messages;
present an updated set of messages which comprises the one or more further messages;
receive a user input associated with a utility of at least one message of the updated set of messages; and
output a feedback associated with the utility to the message generator.

18. The system of claim 17,
wherein the user input comprises a selection of one of the one or more further messages for communication;
wherein the user interface is further configured to:
provide a voice or speech output of the selected message.

19. The system of claim 18, wherein the user interface comprises a multimodal user interface configured to receive user input based at least in part on touch, gaze, speech, bioelectric signals, or any combination thereof.

20. An assistive communication device, comprising:
at least one memory, and
at least one processor operably connected with the at least one memory and configured to:
output a set of communication tokens;
receive a user input associated with selection of one or more communication tokens of the set of communication tokens for constructing a message for communication;
obtain, based at least in part on performing retrieval-augmented generation (RAG) using at least the one or more selected communication tokens, an output comprising one or more messages; and
output the one or more messages.
